(19) United States
(12) Patent Application Publication
(10) Pub. No.: US 2012/0250312 A1
(43) Pub. Date: Oct. 4, 2012

(54) LIGHTING DEVICE FOR RESCUE AND EMERGENCY PRIORITARY VEHICLES, HEAVY TRANSPORTS AND VEHICLES, AND WORK MACHINERY

(76) Inventors: Luciano FRANCESCHELLI, ARICCIA (IT); Angelo MANCINI, ARICCIA (IT)

(21) Appl. No.: 13/427,766

(22) Filed: Mar. 22, 2012

(30) Foreign Application Priority Data
Mar. 29, 2011 (IT) RM2011A000158

(51) Int. Cl. F21V 7/06

(52) U.S. Cl. 362/235

(57) ABSTRACT

A lighting device, in particular a light signaling supplementary device for rescue and emergency prioritary vehicles, heavy transports and vehicles, and work machinery is described. The lighting device has a light source placed on a disposition plane and a semi-parabolic reflector body for the conveying of the light within a predefined exit angular aperture of ±α of the light beam with respect to the disposition plane. A semi-parabolic reflector body of the lighting device can be rotated around a rotation axis that passes in correspondence of a center of said light source and is perpendicular to said disposition plane, in such a way to obtain a light beam which spans a predefined maximal angle around said light source.

### CROSS REFERENCE TO RELATED APPLICATIONS

The present application claims priority to Italian Patent Application No. RM2011A000158, filed on Mar. 29, 2011, which is incorporated herein by reference in its entirety.

### FIELD

The present disclosure relates to a lighting device, in particular a light signaling supplementary device for rescue and emergency prioritary vehicles, heavy transports and vehicles, work machinery.

The lighting device according to the disclosure can be a device of supplementary light signaling to be used, for example, on vehicles that are on emergency and rescue service, and more particularly a light signaling device that incorporates LED light emitters inside an only parabolic cavity which is suited to convey the light beams in a predefined circular sector, and to rotate on a 360° angle without loss of continuity.

### SUMMARY

According to a first aspect of the disclosure, a lighting device comprising a light source placed on a disposition plane and a semi-parabolic reflector body for a conveying of light within a predefined exit angular aperture of ±α of a light beam with respect to said disposition plane, and wherein a semi-parabolic reflector body is suitable to be rotated around a rotation axis that passes in correspondence of the center of said light source and is substantially perpendicular to said disposition plane, to obtain a light beam which spans a predefined maximal angle around said light source, wherein: the light source comprises three or more LEDs which are placed on corresponding application points on a disposition plane and provide an overall emission beam; said rotation axis passes substantially through the center of a circumference of maximum radius r passing through the application points of at the three or more LEDs among said three or more LEDs and enclosing all said application points of said three or more LEDs; said maximum radius r is approximately equal to or larger than 2.3 mm; said semi-parabolic reflector body is a portion of a parabola having a parabolic symmetry axis substantially perpendicular to said rotation axis; said disposition plane whereon said three or more LEDs are disposed is placed at a distance d from the focus of said parabola, the distance d being predetermined such that an application point of an equivalent source of said overall emission beam finds itself substantially on said focus

The details of one or more embodiments of the disclosure are set forth in the accompanying drawings and the description below. Further embodiments of the disclosure will be apparent from the description and drawings, and from the claims.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows an emergency signaling rotating lamp (rotational device with a halogen lamp) in front view (a) and from above (b) without the protection and covering lampshade which is instead shown in (c);

FIG. 2 shows a perspective view of an embodiment of the lighting device according to the present disclosure;

FIG. 3 shows a front view of the device of FIG. 2;

FIG. 4 shows the section A-A as indicated in FIG. 3;

FIG. 5 shows an embodiment of the LEDs in the devices of the previous figures;

FIG. 6 shows a picture of the disposition of the LEDs in an embodiment of the device according to the disclosure: (A) emission plane, (B) reflector focus plane, (C) reflector focus point;

FIG. 7 shows different sighting directions of a vehicle having a flashing device according to the prescriptions of the current homologation regulations;

FIG. 8 shows disposition geometries of the LEDs in tested embodiments of the device according to the disclosure;

FIG. 9 shows different angular emissions, normalized with respect to the measured maximal value, of an embodiment of the device according to the disclosure using blue LEDs, in the cases of 1 LED (r=0 mm) and 3 LEDs (r=2.5-8 mm) wherein r represents the radius of the circle passing through the centers of the LEDs;

FIG. 10 shows different normalized angular emissions of a device according to the disclosure using white light LEDs with a cap/filter of amber color, in the cases of 1 LED (r=0 mm) and 3 LEDs (r=2.5-8 mm);

FIG. 11 shows different normalized angular emissions of an embodiment of the device according to the disclosure using blue LEDs, in the case of 4 LEDs (r=2.5-5 mm);

FIG. 12 shows the different normalized angular emissions of an embodiment of the device according to the disclosure using white light LED with cap/filter of amber color, in the case of 4 LEDs (r=2.5-5 mm);

FIG. 13 shows the different normalized angular emissions of an embodiment of the device according to the disclosure using blue LEDs, in the case of 6 LEDs (r=4-5 mm), in the various dispositions of FIG. 8;

FIG. 14 shows the different normalized angular emissions of an embodiment of the device according to the disclosure using white light LED with cap/filter of amber color, in the case of 6 LEDs (r=4-5 mm), in the different dispositions of FIG. 8;

FIG. 15 shows two thermal images of a dissipating body of an embodiment of the device according to the disclosure containing the LED sources, for different values of radius r of spacing between the LEDs and current intensity I supplied to the LEDs: (a) 1 LED (r=0), I=1 A; (b) 3 LED, r=2.5 mm, I=0.3 A, wherein the hottest regions are represented by white and grey with increasing darkness as the temperature decreases, the coldest regions are represented by grey with a texture made by small circles, circles and triangles in order with decreasing temperature;

FIG. 16 shows as in FIG. 15 three further thermal images of a dissipating body of a device containing the LED sources for different values of radius r of spacing between the LEDs and current intensity I supplied to the LEDs: (a) 3 LED, r=3 mm, I=0.3 A; (b) 3 LED, r=4 mm, I=0.3 A; (c) 3 LED, r=5 mm, I=0.3 A, with the same representation convention as in FIG. 15.

### DETAILED DESCRIPTION

Regulation ECE no. 65 provides rules for homologation of alarm light signaling devices which can be installed on rescue and emergency prioritary vehicles, as well as on work machinery and heavy transports and vehicles (automotive product) at the ECE level (nations as listed in the regulation, among which there is Europe and many other extra-community countries).

In this regard, for example, U.S.A., Canada and other countries connected to them use regulations/directives different but very similar in substance, which should be applied in the case of introduction of these products in their market.

The main prescriptions of the regulation no. 65 to be fulfilled, besides the colorimetric characteristics, are measurements of the intensity of effective light emitted by the devices, which should be detected at a distance of 25 m over an angle of 360° on the horizontal plane (the horizontal plane is intended with respect to a vertical axis of the device) and over vertical angles of +−4° or +−8° with respect to the horizontal plane as a function of the adopted colors, as illustrated in FIG. 7, wherein for the sake of generality a generic angle α of observation of the light device has been indicated (so that it holds for different regulations).

The light can be measured in effective candelas to average it according to the human eye, for example one can take into account, within a mathematical formula of determination of effective intensity, the permanence of light on the retina of the human eye.

Other basic homologation prescriptions included in the Regulation no. 65 are the limits imposed for the time on, time off, the flashing frequency comprised between 2 and 4 Hz to maximize effectiveness of the alarm action of the signaling device.

Other prescriptions include but are not limited to various realization typologies of the devices, photometric characteristics, tests against rain, conformity to mass production, and application marks to be put thereon.

Homologation of a device can be granted by the Transport Ministry of the various countries upon execution and passing of the tests as prescribed e.g. in Regulation no. 65.

Traditional devices of light signaling can consist of a halogen lamp around which a parabolic mirror is made rotating, which direct the light making it turn over the 360°.

The limits of such a device can be in the lifetime of the halogen lamp and in the energy consumption of the same. LED (Light Emitting Diode) lamps are known having lifetimes which are approximately 100 times longer than that of halogen lamps or of other types. The power-LEDs however can suffer of a nontrivial inconvenience of thermal dissipation. Indeed, they can heat up rapidly and, if not suitably dissipated, they can achieve comparatively high temperatures which can entail a shortening of the lifetime of the LEDs and their breaking.

Therefore, efficient collection and conveying of the light rays can be relevant to exploit the produced light and to minimize the power of the LED to be used to a given end. A collection and conveying can depend, in turn, on a choice of LEDs, both for a number and for a reciprocal positioning.

LED flashing devices are known which reproduce a 360° rotating effect by sequentially switching on and off LEDs placed on a circumference subtended by fixed reflecting semi-parabolic surfaces for light beams conveying. In such devices typically one LED at a time emits the light beam and many LEDs are can be necessary to realize the device.

Some embodiments of the disclosure provide an LED light signaling device which can be rotating, and in particular a light signaling supplementary device for rescue and emergency prioritary vehicles, heavy transports and vehicles, work machinery, which can solve problems and overcomes drawbacks which can be associated with such devices.

In some embodiments of the disclosure a lighting device (100) comprises a light source (141, 142,143) placed on a disposition plane and a semi-parabolic reflector body (120) for a conveying of light within a predefined exit angular aperture of ±α of a light beam with respect to said disposition plane, and wherein the semi-parabolic reflector body (120) is suitable to be rotated around a rotation axis (150) that passes in correspondence of the center of said light source (141, 142, 143) and is substantially perpendicular to said disposition plane, to obtain a light beam which spans a predefined maximal angle around said light source, wherein: the light source comprises three or more LEDs placed on corresponding application points on said disposition plane and provide an overall emission beam;
said rotation axis (150) passes substantially through the center of a circumference of maximum radius r passing through the application points of at the three or more LEDs among said three or more LEDs and enclosing all said application points of said three or more LEDs;
said maximum radius r is equal or larger than approximately 2.3 mm;
said semi-parabolic reflector body is a portion of a parabola having a parabolic symmetry axis substantially perpendicular to said rotation axis;
said disposition plane whereon said three or more LEDs are disposed is placed at a distance d from the focus of said parabola, the distance d being predetermined such that an application point of an equivalent source of said overall emission beam finds itself substantially on said focus.

The above definition of maximum radius r is given in order to include also the case, illustrated in the following, of 6 LEDs arranged in such a way that two of them are inside the circumference passing through the other ones. This definition holds for a larger amount of LEDs as well.

In some embodiments, three LEDs are used.

In some embodiments, four LEDs are used.

In some embodiments, said maximum radius r is comprised between approximately 2.3 and 3.3 mm.

In some embodiments, three LEDs are used and said maximum radius r is comprised between approximately 2.5 and 2.9 mm.

In some embodiments, six LEDs are used, and said maximum radius r is comprised between approximately 3.8 and 5.2 mm.

In some embodiments, six LEDs are used, and said maximum radius r is comprised between approximately 4 and 4.8 mm.

In some embodiments, said pre-defined maximum angle is approximately equal to 360°.

In some embodiments, said three or more LEDs are Lambertian LEDs.

In some embodiments, said semi-parabolic reflector body is a hollow body in polycarbonate.

In some embodiments, the internal parabolic-section surface of said semi-parabolic reflector body is reflecting and bright.

In some embodiments, in front of each LED of said three or more LEDs, at a predefined distance from it, an optical group is placed for focusing the light beam emitted from the LED.

In some embodiments, the lighting device comprises a transparent cap cover which covers said three or more LEDs and the reflector body.

In some embodiments, in said transparent cap cover an optical group is integrally formed, which is suitable to improve the distribution of the light over approximately 360°.

In some embodiments, said three or more LEDs are disposed on the vertices of a regular polygon with corresponding three or more vertices, on said disposition plane.

By way of example, an exemplary embodiment of the device according to the disclosure is now described and is not intended to be limiting in any way, It is to be understood that many other embodiments are possible using the same concepts as would be understood by a skilled person.

In particular, it is noted that features of the disclosure as described herein can be implemented both in a device with circular form and in a device that sends light in a predetermined main direction with predefined angles.

In the figures, equal references are used for equal elements.

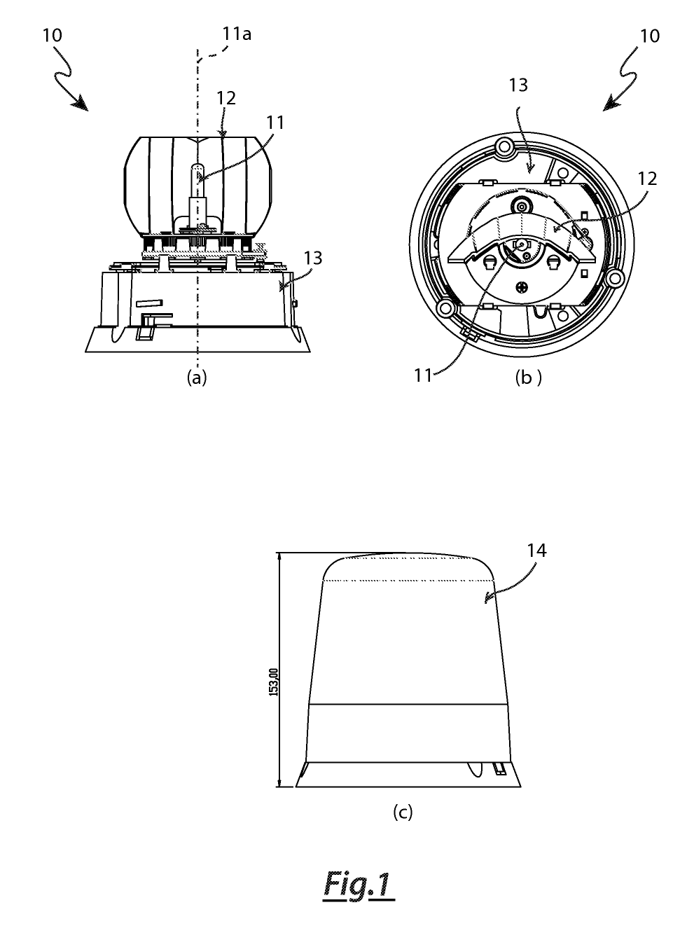

With reference to FIG. 1, a light signaling device 10 according to some known devices comprises a filament electric light bulb 11 centrally above a base 13 of the device 10. The light bulb has symmetry axis 11a oriented vertically with respect to the base 13 and therefore sends its light rays over 360° around such a symmetry axis.

A parabolic mirror 12, which is adapted to rotate around said symmetry axis 11a, screens the light produced by the lamp 11 for all the directions except that identified by the concavity of the parabola (axis of the parabola). In the base 13 a motor is provided which operates the rotation of the parabola 12.

Finally, a transparent (colored) bell-shaped covering 14 (cap) with symmetry axis coinciding with the axis 11a is suitable to be placed on the base 13 and is dimensioned in such a way to contain both the lamp 11 and the parabola 12.

The dimensioning of the parabola 12 is therefore limited to the dimensions of the bell-shaped transparent covering 14.

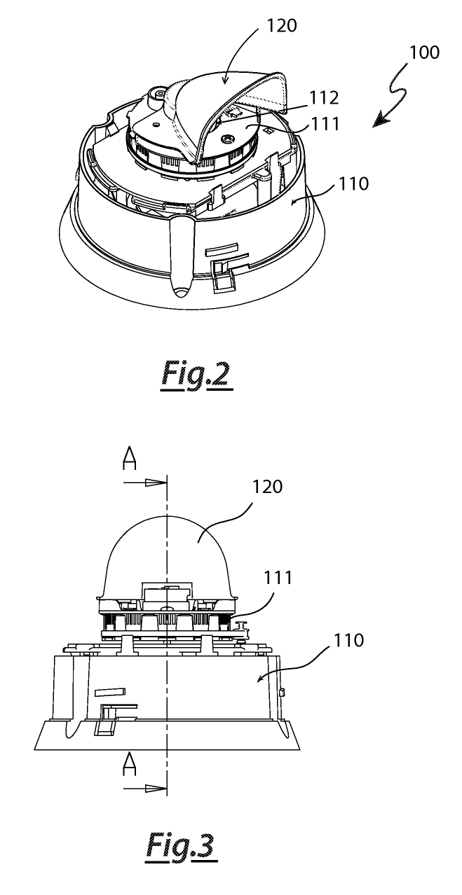

Making now reference to FIGS. 2-5, the device according to the disclosure can be formed by a first fixed base 110 containing a rotational motor and whereon a second rotating base 111 is placed.

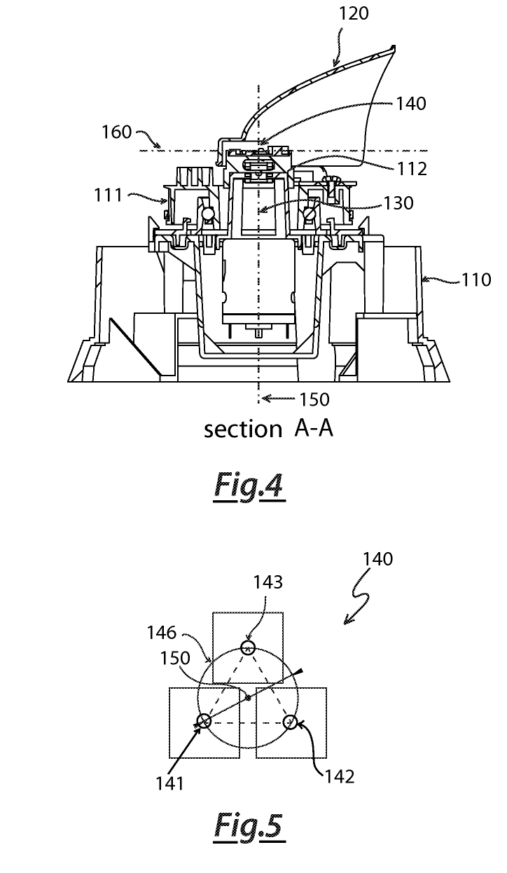

On the rotating base 111a reflecting body 120 can be fixed which can be a substantially parabolic mirror. The rotating base, as shown in the section of FIG. 4, can be holed in the centre, wherefrom instead a fixed internal base 112 protrudes, on which three LEDs 141, 142, 143 can be fixed (referred to as a whole by reference 140). These LEDs are can be contact with a heat dissipation block 130 housed below the base 112.

The disposition of the three LEDs can be symmetrical around the rotation axis of the rotating base 111, which is an axis 150 usually substantially perpendicular to the flat lower surface of the fixed base 110. In some embodiments, three or more LEDs are chosen to give a symmetrical disposition around axis 150, and therefore a light emission as much homogeneous as possible over the 360° of the plane of the base 112 (also called LED disposition plane, e.g. a plane passing though the base 112 and perpendicular to the drawing sheet).

In some embodiments there can be more than three LEDs. In some embodiments, the LEDs are disposed on the vertices of a regular polygon which has its center in a point of the axis 150 and inscribes in a circumference of radius r. In some embodiments, r is at most approximately 4 mm, and more particularly, in some embodiments, not larger than approximately 2.9 mm. From the carried out experiments, it has been derived that, within the limits imposed by the dimensions of the same LEDs, r should be chosen as the lowest one that maximize the collection and diffusion of the light.

The disposition of the LEDs along the height (the height from the disposition plane of the three LEDs along the symmetry axis 150) can be determined as a function of the focus of the parabola 120, in particular of the ideal parabola of which the parabolic minor 120 is essentially a branch.

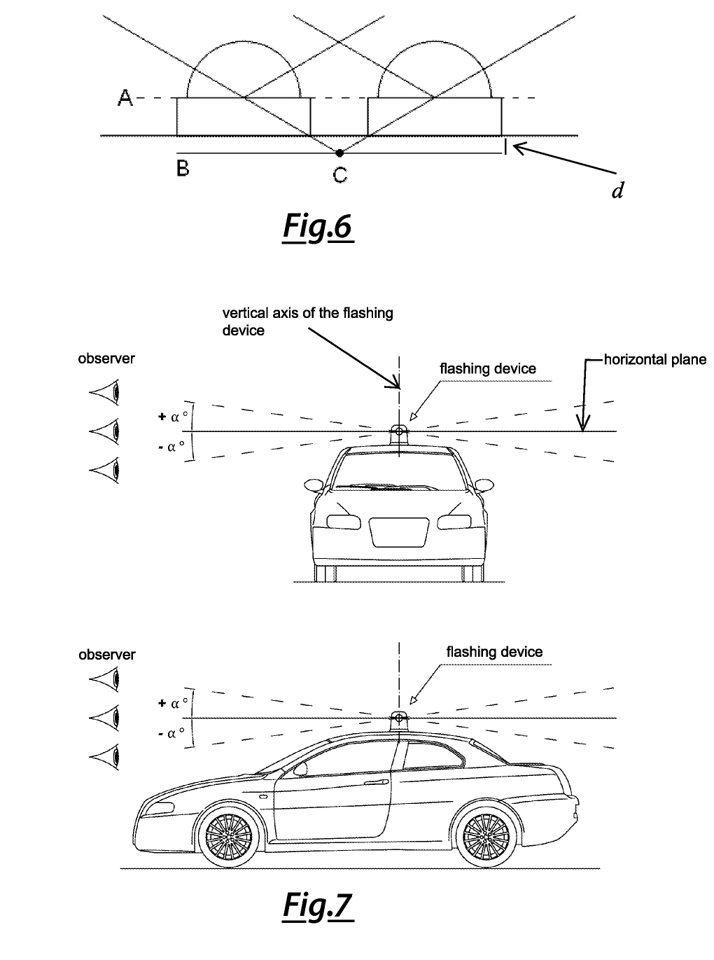

More particularly, and with reference to FIG. 6, the disposition plane, on which the LEDs are arranged, can be positioned at a height different from that of the focus of the parabola. Since there can be at least three different light sources, if the LEDs were at the same height as the focus of the parabola, the resulting emission beam would have had an equivalent source which would have found itself out of focus, not exploiting completely the optical properties of the reflector. In some embodiments, to minimize such occurrences, the LEDs disposition plane can be shifted towards the reflector in order that the equivalent source of the overall emission beam of the source 140 finds itself at a height corresponding to the focus of the reflector.

### EXAMPLES

Embodiments of the disclosure are further illustrated in the following examples, which are provided by way of illustration and are not intended to be limiting.

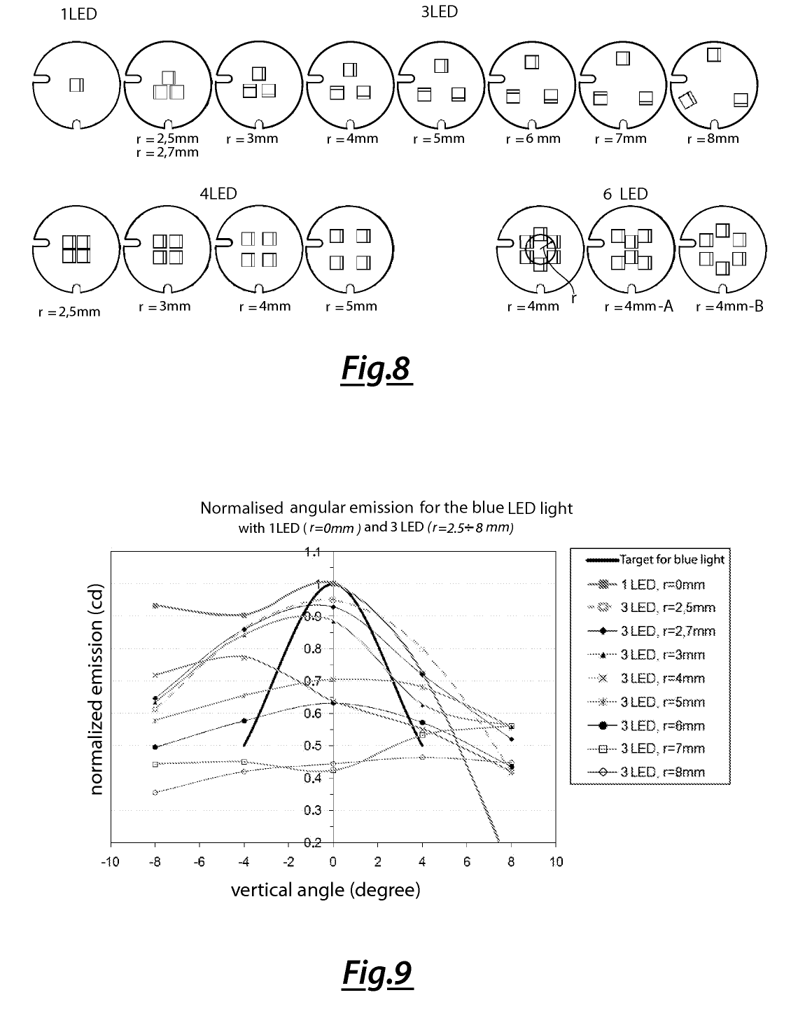

In particular, with reference to FIG. 8 and subsequent figures, some experiments carried out by the Applicants are shown, which indicate exemplary technical concepts of the disclosure and show exemplary embodiments of the disclosure.

A group of experiments has been carried out with the disposition of the LEDs as illustrated in FIG. 8, wherein there are the reference configuration with only one LED and those according to the disclosure as the number of LEDs and the radius of the circumference, along which they are disposed, changes. In the case of six LEDs, three different geometrical dispositions of the LEDs have been tested, which are not all simply circular.

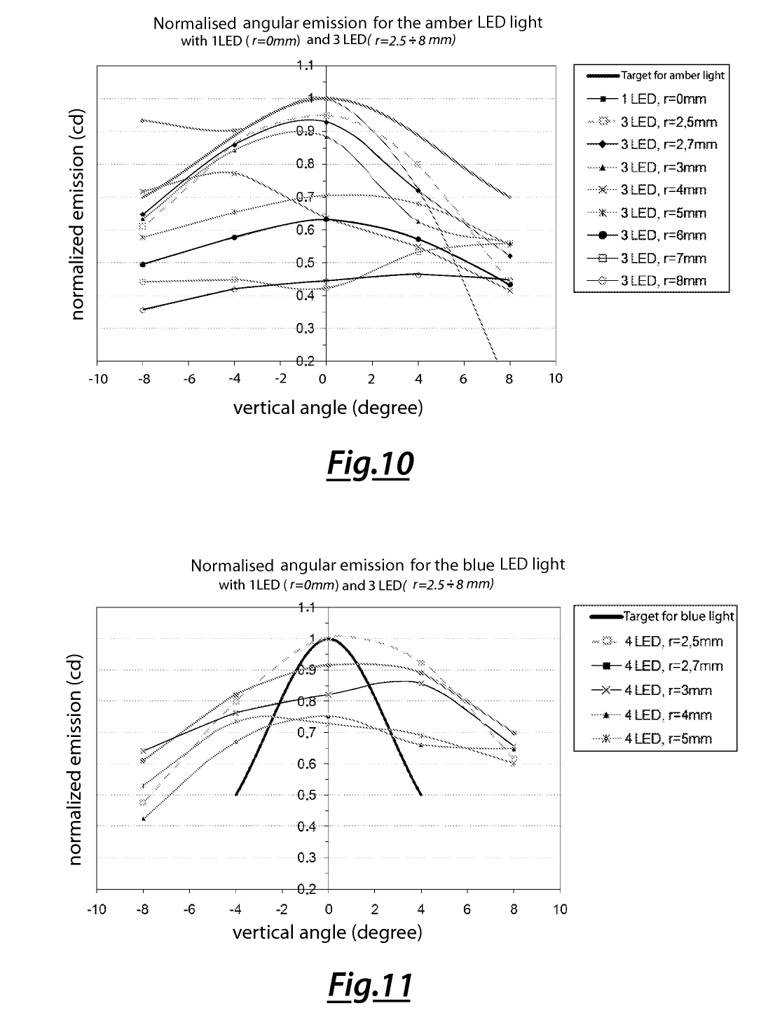

Making reference to FIGS. 9-10, the graphs of the normalized emission light measured in candelas for the device according to the disclosure are shown, for different vertical angles (ordinates) as the LEDs disposition radius r on the disposition plane changes. The emission curves are compared in FIG. 9 with the curve (boldfaced and without identification symbols) which has been preset as the target ideal curve (for the considered reference regulations) for the devices emitting blue light. In FIG. 10, the same emission curves are compared with the current target curve (boldfaced and without identification symbols) for the devices emitting light of amber color.

From the comparison of the curves of FIG. 9 and FIG. 10, one can note that the progression best fitting both the reference curves (blue and amber) is the curve corresponding to r=2.5 mm which is the value of the radius chosen in the disposition of the 3 LEDs on the disposition plane the for the device according to the disclosure. The distribution of the emission values and intensity for r ranging from 4 to 8 mm is instead unsatisfactory, whilst for r=3 mm it is acceptable but still not optimized.

It is further to be noted that the curve relevant to the other LEDs have a very asymmetric progression, even if regarding intensity it could be sufficient only in the blue case. Indeed, in the amber case, the decay of the emission for positive angles is too rapid and, as a consequence, the emission beam would not have the aperture which one would have liked to obtain. In addition, one was obliged to supply the only LED with a current intensity at least three times larger than the usual one to obtain comparable emissions, what influences the dissipation as demonstrated below in the following description.

Besides, as the radius r increases, one notes a deformation and a leveling of the curves of emission measured for vertical angles, which leads to a widening of the light beam emitted by the device, therefore to a moving away from the object of the disclosure which is the obtaining of an emission beam which concentrates the emitted light within the solid angle with vertical aperture (span) of +/−4° for the blue emission, and +/−8° for the “amber” emission.

Coming now to illustrate the experiments with 4 and 6 LEDs, carried out to the end of establishing the minimum an optimal amount of LED light sources to obtain the predetermined target in terms of light intensity, light power distribution, aperture of the light beam emitted by the reflector and dissipation of the heat generated by the LEDs. The 4 and 6 LEDs have been disposed in such a way to respect to as much as possible a circular symmetry and taking into account the minimum spaces required because of the physical dimensions of the individual LED.

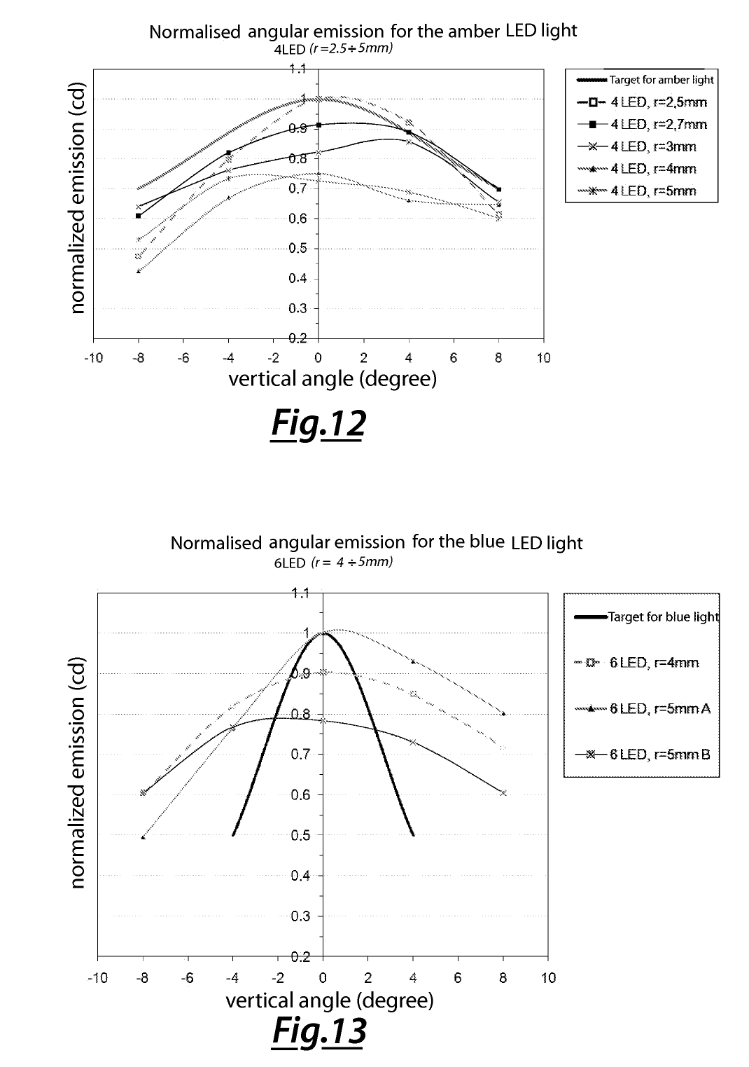

Making reference to FIGS. 11-12, upon increasing the number of light sources to 4 LEDs, it has been observed that also in this case the optimal minimum radius for the LEDs disposition is equal to r=2.5 mm. Indeed, by disposing the sources on a circumference of radius larger than 3 mm, one obtains a light beam from the reflector which comes out to be too much wide and/or asymmetric so that the light efficiency decreases and the fulfillment of the law regulations worsens.

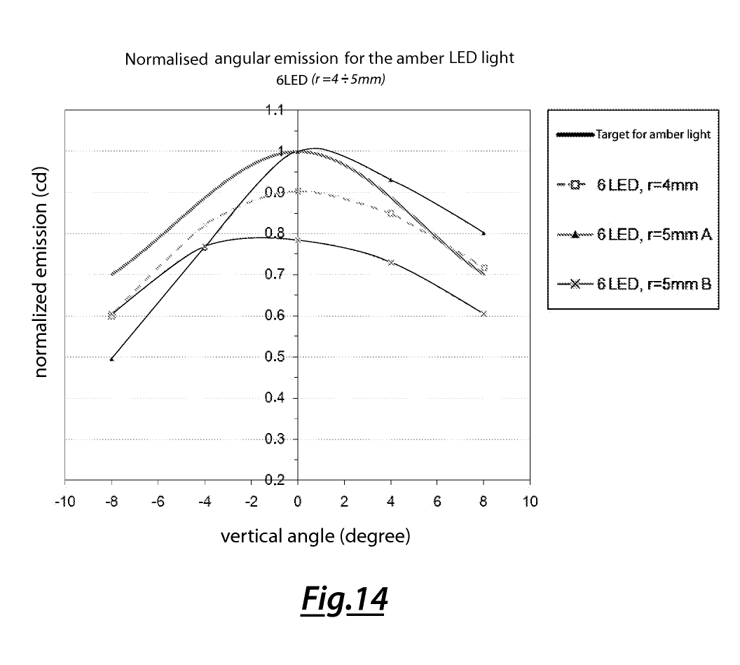

Making now reference to FIGS. 13-14, for a number of sources equal to 6 LEDs, the physical dimensions of the utilized LEDs prevent a disposition on a circumference with the radius smaller than approximately 4 mm. For such large values, one however obtains a light distribution which is more symmetrical and uniform but less concentrated. Recalling indeed that the emission values indicated in the graphs are normalized and that each source is controlled by a current such to produce an overall light intensity equal to that of 1 LED placed in the focus of the semi-parabolic reflector, it appears to be evident that, upon increasing the number of sources, the measured light intensity peak decreases. Almost all the curves are acceptable although not optimized, however the use of 6 LED is more expensive, and by further increasing the radius the efficiency diminishes so much that one cannot think any longer to use a so constructed light device.

This owing to the fact that, on one hand, the individual LED should have a lower light intensity as just said, also in order not to increase the produced heat, and, on the other hand, because of the expansion of the equivalent light surface leading to a light beam with a larger angular aperture (span) and therefore to a lower light density.

Other experiments, not shown here for the sake of conciseness, have confirmed that in the case of 3 or 4 LEDs with r=2.3 mm the result is still acceptable.

Therefore has Applicants have demonstrated that the optimal minimum radius for the disposition of the LEDs which represent the light sources of the device according to the disclosure is of around 2.3-2.5 mm with a minimum number of three light sources needed to obtain a light beam with predetermined aperture and intensity. The same experiments indicate that in the case of 3 or 4 LEDs one can go up to 3.3 mm obtaining an acceptable optical efficiency. The optimal solution is however between 2.5 and 2.9 mm.

Concerning the 6 LEDs, the radius is comprised between 3.8 and 5.2 mm, in the optimal way between 4 and 4.8 mm.

However, not only the influence of the radius on the intensity curve has been studied, but its influence on the heat dissipation as well.

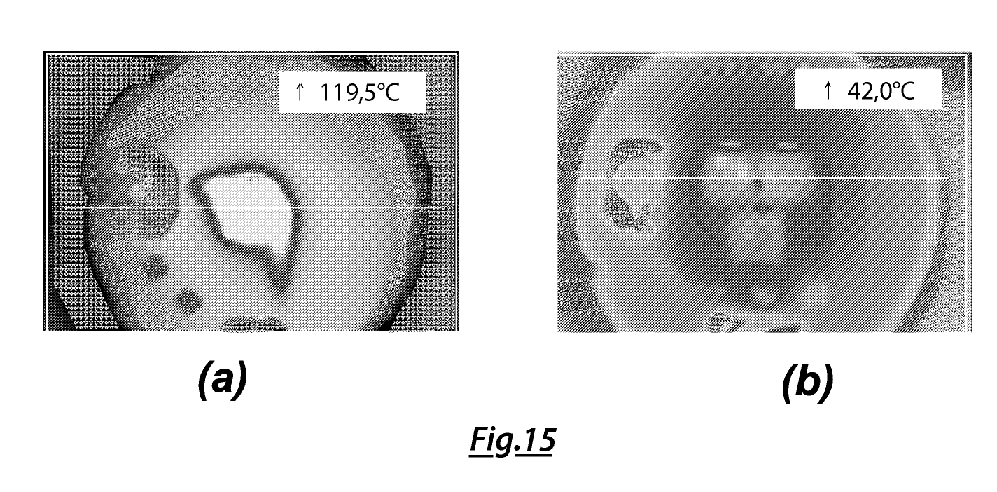

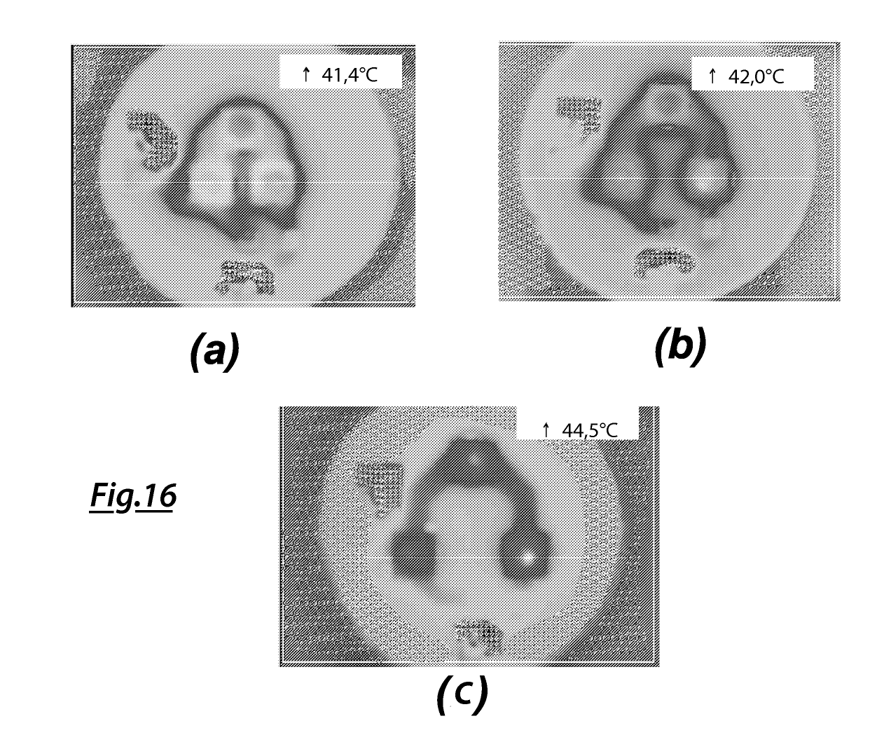

Making reference to FIGS. 15-16, thermal images of the device have been detected for different dimensions of the radius r of the circumference whereon the light sources are placed. The hottest regions are represented by white and grey with increasing darkness as the temperature decreases, the coldest regions are represented by grey with a texture made by small circles, circles and triangles in the order with decreasing temperature.

As shown in FIGS. 15-16, the improvement obtained in the passage from only one source to 3 sources is twofold: on one hand, one has a decrease of the temperature peak of the individual source, on the other hand one has an increase in the dissipation.

Indeed, in FIG. 15 (a) shows that, with an only source, in order to obtain the light intensity needed to achieve the predetermined goal, one should provide the only LED with a current equal to around 330% (1 A) with respect to the condition with 3 sources (0.3 A), and therefore the amount of generated heat comes out to be very large. The peak temperature is slightly less than 120° C. whilst the distribution area is limited to the LED dissipating section being connected to its physical dimensions. In FIG. 15 (b) shows that the first improvement is obtained by dividing the source into 3 distinct points which are placed as close to each other as possible. The temperature peak which is measured in such a way (42° C. in the treated case, in general quoted on the upper right side in each figure), with equal measurement ambient conditions, comes out to be much lower. Indeed, being the sources three instead of one, it is sufficient a smaller current to be able to achieve the same light intensity levels. Moreover, in such a way, the useful dissipation area increases as well.

By increasing the dimension of the radius (FIG. 16 (a)-(c)), one obtains a further improvement concerning the heat dissipation owing to the fact that the sources are more spaced apart and the generated heat is dissipated much better because the thermal gradient increases between the generation point coinciding with the centre of each LED (white/dark grey regions) and the closest regions around (grey with a texture).

However increasing the radius more than r=2.3-2.5 mm or increasing the number of sources beyond 3 LEDs, one has a worsening in the optical behavior.

Applicants have therefore come up with a compromise between the optical and thermal results. The configuration providing the optimal result is obtained by disposing 3 distinct light sources along a circumference with radius r comprised between 2.3 and 3.3 mm. The results are still good for the same radii with 4 LEDs. Concerning the 6 LEDs, sufficient results are obtained for values of the radius between 3.8 and 5.2 mm, optimum results are in the range 4 to 4.8 mm.

Each of the above features of the device according to the disclosure contributes in an essential or secondary way to the achieving of the main aim of the disclosure, i.e. satisfying the technical requirements of the above-mentioned Regulation no. 65 or similar regulations, keeping constructive simplicity, energetic and materials saving, and increasing the efficiency. According to the tests carried out by the Applicants, the solution of the present disclosure provides an optimal irradiation at a low cost. Indeed, directing horizontally the LEDs (by disposing them on a plane parallel to the above mentioned rotation axis) and providing the lighting device with suitable sliding contacts, has been tried with the results of having a complex and economically not attractive structure.

The Applicants tried to utilize an “only” LED multidie, which comprises many integrated LEDs, obtaining however a large production of heat which entailed an increase of the dissipation section (and therefore of the weight, dimensions, efficiency, costs of the lighting device).

In some embodiments, the device comprises a bell-shaped transparent covering (or in general a cap) according to known devices, which covers the assembly of LEDs and the reflector body. Such a transparent covering (colored or not, depending on the use), identifiable by a skilled person, can be reconditioned according to the present disclosure, to obtain the device of the present disclosure, as would be understood by a skilled person.

The present disclosure, owing to the foregoing, allows to simplified and optimize in innovative way the construction of a flashing light signaling supplementary device using LED light, which in some embodiments is achieved by managing a reduced number of components, innovating the system of the light emission and the system of allocation and dissipation of the heat produced by the utilized LEDs, and cutting the management costs of the device in terms of increase in lifetime (e.g. 100 times more than the rotating device using halogen lamp) and in terms of absorbed energy (around 10 times).

The examples set forth above are provided to give those of ordinary skill in the art a complete disclosure and description of how to make and use the embodiments of the Lighting Device For Rescue and Emergency Prioritary Vehicles, Heavy Transports and Vehicles, and Work Machinery of the disclosure, and are not intended to limit the scope of what the inventors regard as their disclosure. Modifications of the above-described modes for carrying out the disclosure can be used by persons of skill in the art, and are intended to be within the scope of the following claims.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a”, “an”, and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications can be made without departing from the spirit and scope of the present disclosure. Accordingly, other embodiments are within the scope of the following claims.

What is claimed is:

1. A lighting device comprising a light source placed on a disposition plane and a semi-parabolic reflector body for a conveying of light within a predefined exit angular aperture of ±α of a light beam with respect to said disposition plane,
wherein:
the semi-parabolic reflector body is suitable to be rotated around a rotation axis that passes in correspondence of the center of said light source and is substantially perpendicular to said disposition plane, to obtain a light beam which spans a predefined maximal angle around said light source;
the light source comprises three or more LEDs which are placed on corresponding application points on said disposition plane and provide an overall emission beam;
said rotation axis passes substantially through the center of a circumference of maximum radius r passing through the application points of the three or more LEDs among said three or more LEDs and enclosing all said application points of said three or more LEDs;
said maximum radius r is equal to or larger than approximately 2.3 mm;
said semi-parabolic reflector body is a portion of a parabola having a parabolic symmetry axis substantially perpendicular to said rotation axis; and
said disposition plane whereon said three or more LEDs are disposed is placed at a distance d from the focus of said parabola, the distance d being predetermined such that an application point of an equivalent source of said overall emission beam finds itself substantially on said focus.

2. The device according to claim 1, wherein said three or more LEDs are three LEDs.

3. The device according to claim 1, wherein said three or more LEDs are four LEDs.

4. The device according to claim 2, wherein said maximum radius r is comprised between approximately 2.3 and 3.3 mm.

5. The device according to claim 4, wherein said maximum radius r is comprised between approximately 2.5 and 2.9 mm.

6. The device according to claim 1, wherein said three or more LEDs are six LEDs and said maximum radius r is comprised between approximately 3.8 and 5.2 mm.

7. The device according to claim 6, wherein said maximum radius r is comprised between approximately 4 and 4.8 mm.

8. The device according to claim 1, wherein said pre-defined maximum angle is equal to approximately 360°.

9. The device according to claim 1, wherein said three or more LEDs are Lambertian LEDs.

10. The device according to claim 1, wherein said semi-parabolic reflector body is a hollow body in polycarbonate.

11. The device according to claim 10, wherein an internal parabolic-section surface of said semi-parabolic reflector body is reflecting and bright.

12. The device according to claim 1, wherein in front of each LED of said three or more LEDs, at a predefined distance from each LED, an optical group is placed for focusing the light beam emitted from the LED.

13. The device according to claim 12, further comprising a transparent cap cover which covers said three or more LEDs and the reflector body.

14. The device according to claim 13, wherein in said transparent cap cover an optical group is integrally formed, which is suitable to improve a distribution of the light over 360°.

15. The device according to claim 1, wherein said three or more LEDs are disposed on vertices of a regular polygon with corresponding three or more vertices, on said disposition plane.
